(19) United States
(12) Patent Application Publication
(10) Pub. No.: US 2002/0083426 A1
(43) Pub. Date: Jun. 27, 2002

(54) Installation of network components or services

(76) Inventor: Rajasekhar Sistla, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/751,918

(22) Filed: Dec. 27, 2000

(51) Int. Cl. G06F 9/455

(52) U.S. Cl. 717/168

(57) ABSTRACT

Installing a network component or service on a computer includes automatically loading the network component or service on the computer in response to a process-initiating event and automatically binding existing network adapters to the network component or service.

### BACKGROUND

This invention relates to installation of network components or services.

Vendors supply network components or services with INF (information) files which contain, for example, information describing names of required network components or services, driver files, dependencies and registry updates to be performed. For example, Microsoft provides INF files for Transmission Control Protocol/Internet Protocol (TCP/IP).

Software applications may need a particular network component or service to be installed on a computer. Currently, if the particular network component or service is not installed on the computer, an administrator may manually install it. The administrator may do this by selecting the “Network” applet in the control panel of the computer. This typically launches an installation wizard that leads the administrator through a number of steps to install the desired network component or service on the computer. Then, the network administrator typically reboots the computer.

### BRIEF DESCRIPTION OF DRAWINGS

FIG. 1 illustrates a computer system.

FIG. 2 is a flowchart of a method according to the invention.

### DETAILED DESCRIPTION

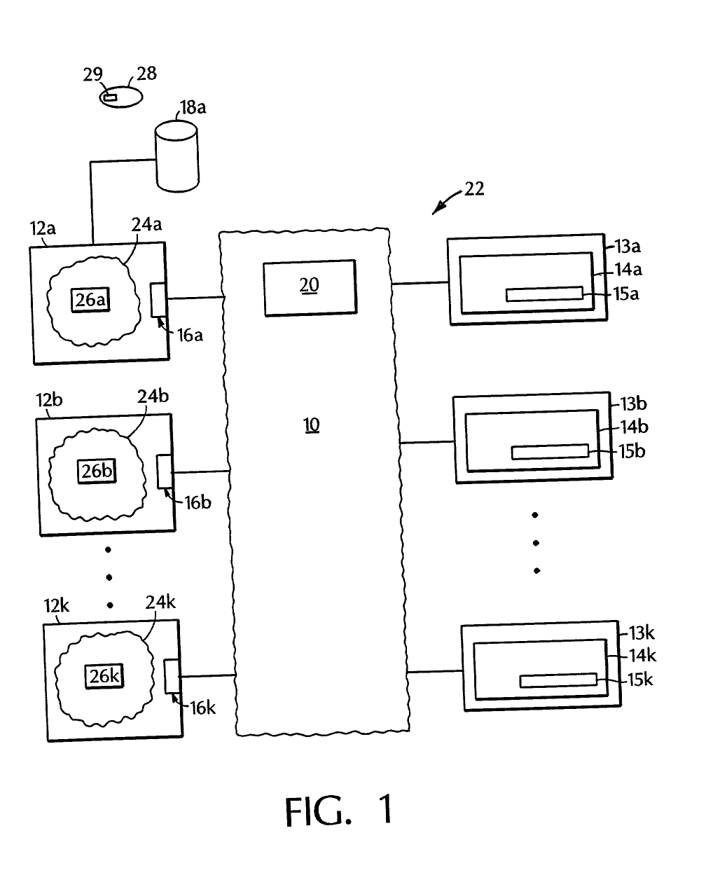

FIG. 1 illustrates an exemplary computer system 22 that includes computers 12a, 12b . . . 12k connected through network adapters 16a, 16b . . . 16k to a computer network 10. The network adapters 16a, 16b . . . 16k are cards installed in the computers 12a, 12b . . . 12k to enable the computers to communicate with the computer network 10. The computers 12a, 12b . . . 12k run operating systems 24a, 24b . . . 24k, for example, Windows NT 4.0™. The operating systems 24a, 24b . . . 24k include binding engines 26a, 26b . . . 26k. The binding engines review network components and services installed in a computer. They identify which components or services are new and make the necessary registry entries to bind the network interface cards 16a, 16b . . . 16k to the new components or services.

A disk drive 18a is connected to one of the computers 12a. A shared network storage location 20 is part of the computer network 10 and can be accessed by any one of the attached computers 12a, 12b . . . 12k. Several network components or services 14a, 14b . . . 14k, also are connected to the computer network 10. The network components or services 14a, 14b . . . 14k are typically stored on memory storage devices 13a, 13b . . . 13k. Alternately, the network components or services 14a, 14b . . . 14k may be stored on other network memory storage devices, including memory storage devices in computers 12a, 12b . . . 12k or on other computer system 22 components. Examples of network components or services 14a, 14b . . . 14k include NetBEUI protocol, network monitor agent services, and TCP/IP. Each network component or service 14a, 14b . . . 14k has a specific INF file 15a, 15b . . . 15k associated with it.

Some computer applications require that specific network components or services be installed on a computer 12a, 12b . . . 12k in order to run effectively. Computer programs include specification of information (INF) files 15a, 15b . . . 15k with their software detailing the various network components and services 14a, 14b . . . 14k needed by the program to run properly. Each INF file 15a, 15b . . . 15k also contains information regarding driver files, dependencies, and registry updates to be performed.

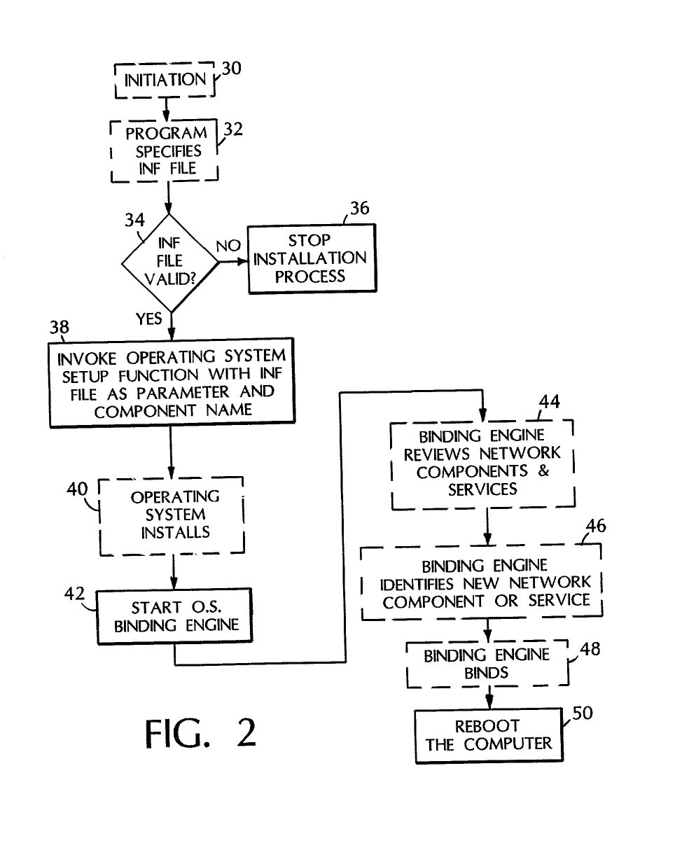

For example, assume that the computer 12a runs the operating system Windows NT 4.0™, and that a software program, for example, Intel's Netport Express™ software is to be installed from a disk 28 (e.g. a compact disk) to a computer 12a. An automatic installation agent 29 is included on the disk. A network administrator would insert the disk into the disk drive 18a. The network administrator would then start the software program startup process. This software program startup process is represented by the box labeled initiation 30 in the flowchart of FIG. 2.

Initiation 30 represents an action that triggers the routine of FIG. 2 and can be accomplished in several other ways. For example, the network administrator can install the automatic installation agent and the necessary files (e.g. INF files) at the shared network storage location 20 and setup a shortcut to the shared network storage location 20. Network users then can initiate 30 the routine of FIG. 2 by selecting a shortcut icon on their desktop computers 12a . . . 12k. According to another technique, the network administrator can configure the automatic installation agent with the necessary files (e.g., INF files 15a, 15b . . . 15k) so that the routine of FIG. 2 is automatically initiated 30 when a user logs onto the network. Other initiation techniques are also possible.

Following initiation 30, the software program specifies 32 the information (INF) file 15a, as well as the name of the network component or service 14a that is to be installed to the installation agent 29. The installation agent 29 determines 34 whether the INF file is valid. For example, in a Microsoft Windows NT 4.0™ environment, the installation agent 29 uses a well-known application program interface (API) method to determine whether the INF file is valid for use in a Windows NT 4.0™ environment. The installation agent 29 also checks that the network component or service 14ato be installed at the computer 12a is available in the computer system 22. If the installation agent determines that a particular INF file 15a is not valid, it stops 36 the installation process. If the installation agent 29 determines that an INF file is valid, it continues with the installation process.

Following successful validation of the INF file, the installation agent invokes 38 the operating system program setup function to install the network component or service 14a, using the INF file as the parameter and specifying the name of the network component or service 14a to be installed. The operating system 24a then installs 40 the network component or service 14a to the computer 12a. Windows NT 4.0™, for example, accomplishes that by using a “setup.exe” executable file. This executable file is located in the “System32” folder of the computer 12a.

Once the new network component or service 14a is installed on the computer 12a, the installation agent 29 starts 42 the operating system 24a binding engine 26a. The binding engine 26a reviews 44 all the network components and services installed on the computer 12a. Next, the binding engine 26a identifies 46 the newly added component or service 14a and makes the necessary registry entries to bind 48 the symbolic addresses in the variables and instructions of the network component or service 14a to the real system addresses of the network adapter card 16a. Finally, the installation agent 29 reboots 50 the computer 12a. This allows the computer system changes to become effective.

The foregoing techniques may be incorporated into any product software setup program (e.g., a software setup program written with InstallShield™ or Wise™) that installs network components. Additionally, the techniques may be used as a mass deployment mechanism for a network component or service. A mass deployment mechanism is used to automatically install a network component or service on a large group of computers attached to a network. Also, the techniques described herein may be adapted for use with operating systems other than Microsoft Windows NT 4.0™. Various features of the system may be implemented with hardware, software or with a combination of hardware and software. For example, some aspects of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer, for configuring and operating the computer when the storage medium is read by the computer to perform the functions described above. The techniques provide a faster and more efficient way to install network components and services and minimizes network administrator effort during the installation process.

Other embodiments are within the scope of the following claims.

What is claimed is:

1. A method of installing a network component or service on a computer comprising:
automatically loading the network component or service on the computer in response to a process-initiating event; and
automatically binding an existing network adapter to the network component or service.

2. The method of claim 1 further comprising automatically rebooting the computer following said automatically binding.

3. The method of claim 1 including invoking a network operating system to perform loading of the network component or service on the computer.

4. The method of claim 3 including using a binding engine of the operating system to bind the existing network adapter to the network component or service.

5. The method of claim 1 wherein the process-initiating event includes selecting a shortcut to a shared network location from the computer.

6. The method of claim 1 wherein the process-initiating event includes executing an operating system command line.

7. The method of claim 1 wherein the process-initiating event is part of a software setup program execution.

8. The method of claim 1 wherein the process-initiating event is part of a user login sequence to the computer.

9. The method of claim 1 wherein the process-initiating event is part of a mass deployment of the new network component or service.

10. An apparatus comprising:
a network adapter; and
a processor configured to load a network component or service in the apparatus automatically in response to a process-initiating event and to bind the network adapter to the network component or service automatically.

11. The apparatus of claim 10 wherein the processor is further configured to reboot the apparatus automatically after automatic binding.

12. The apparatus of claim 10 further comprising a network operating system, wherein the processor is further configured to invoke the network operating system to perform the automatic loading of the network component or service.

13. The apparatus of claim 12 wherein the operating system comprises a binding engine that is utilized to bind the network adapter to the network component or service.

14. An article comprising a computer-readable medium that stores computer-executable instructions for causing a computer system to:
automatically load a network component or service on a computer in response to a process-initiation event; and
automatically bind an existing network adapter to the network component or service.

15. The article of claim 14 further comprising computer-executable instructions on the computer-readable medium for causing the computer system to automatically reboot the computer after binding.

16. The article of claim 14 including instructions for causing a network operating system to be utilized to perform loading of the network component or service on the computer.

17. The article of claim 16 including instructions for causing a binding engine of the network operating system to bind the existing network adapter to the network component or service.

18. A computer system comprising:
a computer including a network adapter;
a network component or service;
a computer network that connects the computer to the network component or service; and
a processor;
wherein the processor is configured to automatically load the network component or service on the computer in response to a process initiation event, and to automatically bind the network adapter to the network component or service.

19. The computer system of claim 18 wherein the processor is further configured to automatically reboot the computer after binding.

20. The computer system of claim 18 further comprising a network operating system that is utilized by the processor to load the network component or service.

21. The computer system of claim 20 wherein the operating system comprises a binding engine that binds the network adapter to the network component or service.
